(19) United States
(12) Patent Application Publication
(10) Pub. No.: US 2006/0106853 A1
(43) Pub. Date: May 18, 2006

(54) Allocation and Scaling of Descriptor Lists.

(75) Inventors: Vadim Makhervaks, Yokneam (IL); Leah Shalev, Zichron-Yaakov (IL)

Correspondence Address: International Business Machines Corporation, New Orchard Road, Armonk, NY, 10504, US

(73) Assignee: INTERNATIONAL BUSINESS MACHINES CORPORATION, Armonk, NY (US)

(21) Appl. No.: 10/904,580

(22) Filed: Nov. 17, 2004

(51) Int. Cl. G06F 17/00; G06F 7/00

(52) U.S. Cl. 707/102

(57) ABSTRACT

A system for managing descriptor lists, the system including a plurality of descriptor lists, and a descriptor list manager operative to chain any of the descriptor lists by configuring at least one entry in at least a first one of the descriptor lists to indicate the location of a second one of the descriptor lists, and manage the chain of descriptor lists as a single continuous descriptor list.

### BACKGROUND OF THE INVENTION

### Field of the Invention

The present invention relates to computer data structures in general, and more particularly to the allocation of dynamic descriptor lists for a TCP/IP stack.

The processing of TCP/IP information typically includes a point of contact between a hardware device, such as a Network Interface Card (NIC), and software, such as network application software (NAS) executing on a host computer. Information typically travels in both directions, from the NIC to the NAS and from the NAS to the NIC. One technique to facilitate the communication between these two entities is the utilization of descriptor lists.

A descriptor list is composed of a list of entries, where each entry is typically a command, a data buffer or a reference to a data buffer. Typically, the NAS may insert one or more entries into the descriptor list at any point in time to communicate with the NIC, which in turn typically reads and writes to and from data buffers referred to by the entries in the descriptor list. The size of the descriptor list is typically a function of the speed with which the TCP/IP information travels and the speed with which the NIC or the NAS process the descriptor list entries, typically the more data that flows and the slower the processing speed, the larger the list.

Given the increasing demands placed on TCP/IP communication hardware and software, it has become more important to regulate the size of the descriptor list.

### SUMMARY OF THE INVENTION

In one aspect of the present invention a system is provided for managing descriptor lists, the system including a plurality of descriptor lists, and a descriptor list manager operative to chain any of the descriptor lists by configuring at least one entry in at least a first one of the descriptor lists to indicate the location of a second one of the descriptor lists, and manage the chain of descriptor lists as a single continuous descriptor list.

In another aspect of the present invention the configured entry is located at the end of the first descriptor list.

In another aspect of the present invention the configured entry is at a location designated as an insertion point for the next element to be inserted into the first descriptor list.

In another aspect of the present invention the first descriptor list includes a first entry located at the end of the first descriptor list and a second entry intermediate the beginning and end of the first descriptor list, where the first entry indicates a location within the first descriptor list and where the second entry indicates the location of the second descriptor list.

In another aspect of the present invention the descriptor list manager is operative to remove the second entry and configure the first entry to indicate the location of the second descriptor list.

In another aspect of the present invention the descriptor list manager is operative to remove the configured entry subsequent to designating a location in the second descriptor list as an extraction point for the next element to be extracted from the descriptor lists.

In another aspect of the present invention the descriptor list manager is operative to remove the configured entry subsequent to designating the location of the configured entry in the first descriptor list as an insertion point for the next element to be inserted into the descriptor lists.

In another aspect of the present invention a method is provided for managing descriptor lists, the method including chaining a plurality of descriptor lists by configuring at least one entry in at least a first one of the descriptor lists to indicate the location of a second one of the descriptor lists, and managing the chain of descriptor lists as a single continuous descriptor list.

In another aspect of the present invention the method further includes locating the configured entry at a location designated as an insertion point for the next element to be inserted into the first descriptor list.

In another aspect of the present invention the method further includes configuring the first descriptor list to include a first entry located at the end of the first descriptor list and a second entry intermediate the beginning and end of the first descriptor list, where the first entry indicates a location within the first descriptor list and where the second entry indicates the location of the second descriptor list.

In another aspect of the present invention further the method includes removing the second entry and configuring the first entry to indicate the location of the second descriptor list.

In another aspect of the present invention the method further includes removing the configured entry subsequent to designating a location in the second descriptor list as an extraction point for the next element to be extracted from the descriptor lists.

In another aspect of the present invention the method further includes removing the configured entry subsequent to designating the location of the configured entry in the first descriptor list as an insertion point for the next element to be inserted into the descriptor lists.

In another aspect of the present invention a computer program is provided embodied on a computer-readable medium, the computer program including a first code segment operative to chain a plurality of descriptor lists by configuring at least one entry in at least a first one of the descriptor lists to indicate the location of a second one of the descriptor lists, and a second code segment operative to manage the chain of descriptor lists as a single continuous descriptor list.

In another aspect of the present invention the computer program further includes a third code segment operative to locate the configured entry at a location designated as an insertion point for the next element to be inserted into the first descriptor list.

In another aspect of the present invention the computer program further includes a third code segment operative to configure the first descriptor list to include a first entry located at the end of the first descriptor list and a second entry intermediate the beginning and end of the first descriptor list, where the first entry indicates a location within the first descriptor list and where the second entry indicates the location of the second descriptor list.

In another aspect of the present invention the computer program further includes a fourth code segment operative to remove the second entry and configuring the first entry to indicate the location of the second descriptor list.

In another aspect of the present invention the computer program further includes a third code segment operative to remove the configured entry subsequent to designating a location in the second descriptor list as an extraction point for the next element to be extracted from the descriptor lists.

In another aspect of the present invention the computer program further includes a third code segment operative to remove the configured entry subsequent to designating the location of the configured entry in the first descriptor list as an insertion point for the next element to be inserted into the descriptor lists.

In another aspect of the present invention a method is provided for implementing descriptor list management, the method including providing a plurality of descriptor lists, providing a descriptor list manager, and configuring the descriptor list manager to chain any of the descriptor lists by configuring at least one entry in at least a first one of the descriptor lists to indicate the location of a second one of the descriptor lists, and manage the chain of descriptor lists as a single continuous descriptor list.

### BRIEF DESCRIPTION OF THE DRAWINGS

The present invention will be understood and appreciated more fully from the following detailed description taken in conjunction with the appended drawings in which:

FIG. 1 is a simplified illustration of a system for managing a descriptor list, useful in understanding the present invention;

FIG. 2 is a simplified illustration of chained descriptor lists, constructed and operative in accordance with a preferred embodiment of the present invention;

FIG. 3A is a simplified illustration of an intermediate branch entry, constructed and operative in accordance with a preferred embodiment of the present invention;

FIG. 3B is a simplified flow chart illustration of a method for allocating intermediate branch entries, operative in accordance with a preferred embodiment of the present invention;

FIG. 4A is a simplified illustration of a scaleable descriptor list, constructed and operative in accordance with a preferred embodiment of the present invention; and

FIG. 4B is a simplified flow chart illustration of a method for resizing a descriptor list, operative in accordance with a preferred embodiment of the present invention.

### DETAILED DESCRIPTION OF PREFERRED EMBODIMENTS

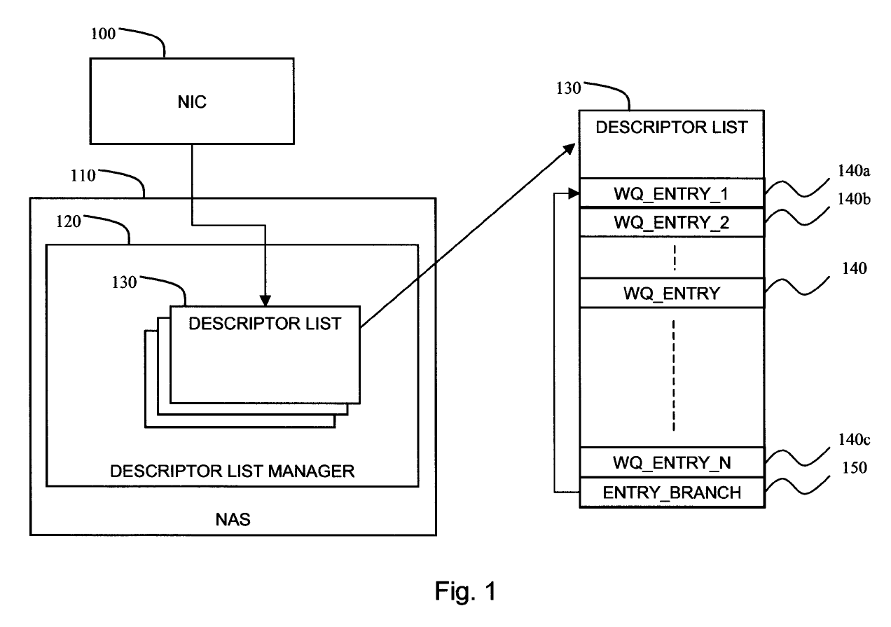

Reference is now made to FIG. 1, which is a simplified illustration of system for managing a descriptor list constructed and operative in accordance with a preferred embodiment of the present invention. In FIG. 1 a NAS 110 communicates with a NIC 100 via a descriptor list manager 120 that typically maintains one or more descriptor lists 130, such as in a system that supports the TCP/IP protocol. Each descriptor list 130 preferably includes one or more WQ_ENTRYs 140, which are typically employed to store a command, a data buffer or a reference to a data buffer. During the processing of TCP/IP information, NAS 110 may instruct descriptor list manager 120 to insert/extract WQ_ENTRYs 140 into/from descriptor list 130.

Typically, descriptor list manager 120 maintains a mechanism for monitoring and traversing the descriptor lists 130, such as two pointers, an insertion pointer and an extraction pointer, that indicate, respectively, the locations where subsequent WQ_ENTRY insertions and extractions should occur in descriptor list 130. For example, NAS 110 may request that descriptor list manager 120 insert two new entries. These two entries will be placed by descriptor list manager 120 in the first two available locations, labeled WQ_ENTRY_1 140a and WQ_ENTRY_2 140b in FIG. 1, as indicated by the insertion pointer. The insertion pointer in descriptor list manager 120 may then be updated to point to the next available location for insertion, such that the next insertion will occur after WQ_ENTRY_2 140b.

Preferably, the process of insertion of WQ_ENTRYs 140 will continue in this fashion until the next available position in the descriptor list 130 to which the insertion pointer would normally be advanced is populated by an ENTRY_BRANCH 150, which is typically inserted at the end of descriptor list 130. In this case, the insertion pointer is preferably updated to point to a new location within descriptor list 130 specified by ENTRY_BRANCH 150. In this manner, descriptor list manager 120 may implement a cyclic buffer.

Typically, NIC 100 employs a Direct Memory Access (DMA) mechanism to read one or more WQ_ENTRYs 140 and their referenced data from descriptor list 130. Furthermore, NIC 100 may also communicate, independent of the DMA mechanism, to descriptor list manager 120 the status of the WQ_ENTRYs 140, such as by writing control information into the WQ_ENTRY 140 or by making this information available to descriptor list manager 120 in a register on NIC 100.

Descriptor list manager 120 preferably monitors descriptor list 130 to determine its status. Should descriptor list 130 be full, i.e. unable to receive any more inserts, descriptor list manager 120 may suspend future insertions until room in descriptor list 130 becomes available. For example, descriptor list manager 120 may employ an extraction pointer to indicate the location of the next extraction, i.e. until where NIC 100 has finished processing. Should the insertion pointer be updated such that it points to the same location in descriptor list 130 as does the extraction pointer, e.g. NAS 110 attempts to insert new WQ_ENTRYs 140, descriptor list manager 120 may suspend future insertions until NIC 100 finishes extracting the current set of WQ_ENTRYs 140 available in descriptor list 130.

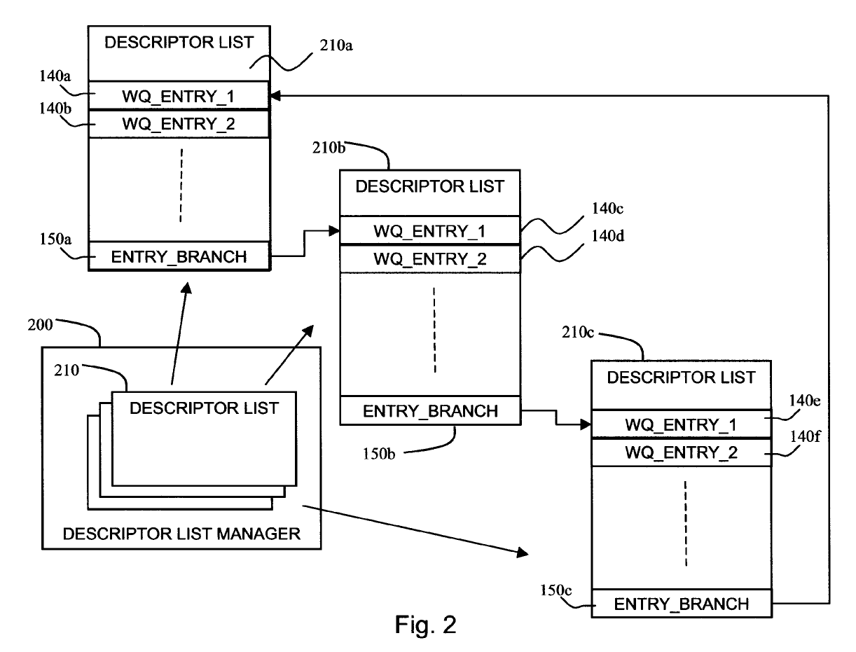

Reference is now made to FIG. 2, which is a simplified illustration of chained descriptor lists, constructed and operative in accordance with a preferred embodiment of the present invention. In the system of FIG. 2, a descriptor list manager 200 typically maintains multiple descriptor lists 210 chained together to operate as a single continuous descriptor list. Descriptor list manager 200 preferably functions in the same manner as descriptor list manager 120, with the notable exception that ENTRY_BRANCH 150a may be configured to indicate the location of a different descriptor list 210, such as a descriptor list 210b. Descriptor list manager 200 preferably chains new descriptor lists when they are required and unchains them when they are no longer necessary. For example, at initiation time NAS 110 may instruct descriptor list manager 200 to prepare for a large burst of TCP/IP traffic. Descriptor list manager 200 preferably links to a descriptor list 210b to create a chained descriptor list, to store additional WQ_ENTRYs 140, by setting ENTRY_BRANCH 150a in descriptor list 210a to point to WQ_ENTRY_1 110c in descriptor list 210b. Should the single additional descriptor list 210b not be sufficient for the storage of WQ_ENTRYs 140, descriptor list manager 200 may continue the process of chaining new descriptor lists by chaining a descriptor list 210c and setting an ENTRY_BRANCH 150b in descriptor list 210b that points to WQ_ENTRY_1 140e in descriptor list 210c. In this fashion descriptor list manager 200 is not limited to processing TCP/IP information in a single descriptor list 100.

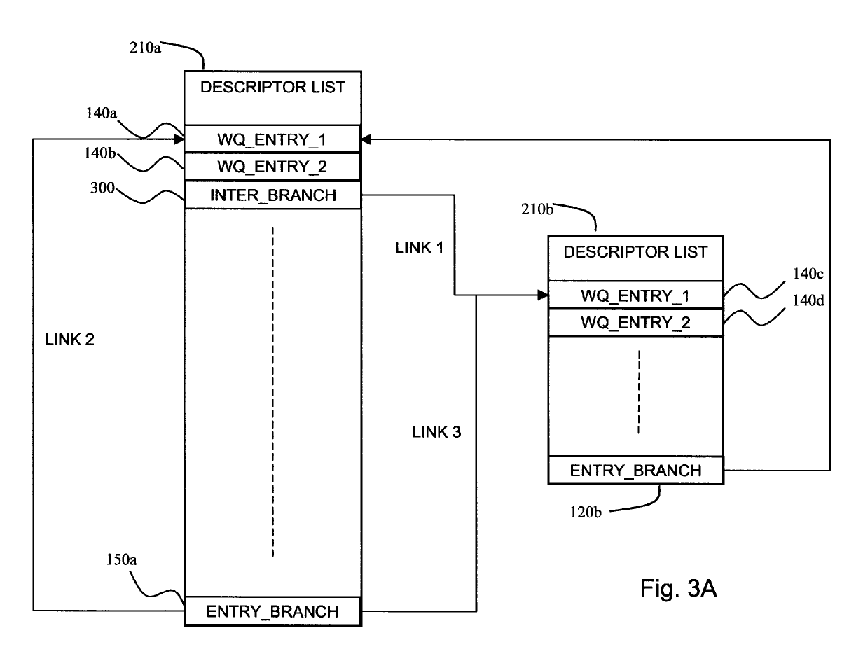

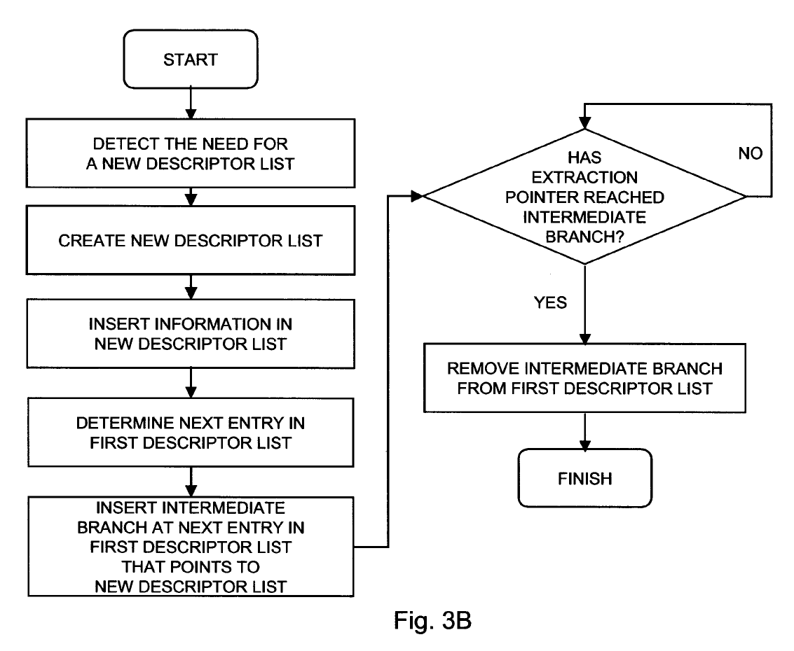

Reference is now made to FIG. 3A, which is a simplified illustration of an intermediate branch entry, constructed and operative in accordance with a preferred embodiment of the present invention, and to FIG. 3B, which is a simplified flow chart illustration of a method for allocating intermediate branch entries, operative in accordance with a preferred embodiment of the present invention. In the system of FIG. 3A, descriptor list manager 200 shown in FIG. 2 is further enhanced to allow for the insertion of an INTER_BRANCH 300, preferably in addition to ENTRY_BRANCH 150. INTER_BRANCH 300 is preferably inserted to redirect the processing of information from a first descriptor list to a second descriptor list. For example, INTER_BRANCH 300 may function in a manner similar to ENTRY_BRANCH 150a with two notable exceptions. First, while ENTRY_BRANCH 150a is typically inserted at the end of descriptor list 200a, INTER_BRANCH 300 is preferably inserted at the current active location, i.e. the point of next insertion, such as the location indicated by descriptor list manager's 200 insertion pointer. Secondly, INTER_BRANCH 300 differs from ENTRY_BRANCH 150a in that descriptor manager 200 preferably removes INTER_BRANCH 300 when it is no longer needed. For example, when an extraction pointer is employed, INTER_BRANCH 300 may be removed after the extraction pointer has been updated to point to the location indicated by INTER_BRANCH 300. Alternatively, INTER_BRANCH 300 may be removed when the insertion pointer has been updated to point to the location in which INTER_BRANCH 300 is stored.

Thus, in the method of FIG. 3B descriptor list manager 200 preferably detects the need for a new descriptor list, typically due to a predefined measure or an explicit request by the NAS, and allocates a new descriptor list 210b. Next, descriptor list manager 200 preferably inserts at the location of the next entry in descriptor list 210a an INTER_BRANCH 300, which indicates that the next WQ_ENTRY 140 is located in the newly created descriptor list 210b along LINK 1 shown in FIG. 3A. Subsequently, all new insertions of WQ_ENTRYs 140, e.g. WQ_ENTRY 140c and WQ_ENTRY 140d, are placed in the new descriptor list 210b. NIC 100 may continue extracting WQ_ENTRYs 140 from descriptor list 210a, following ENTRY_BRANCH 150a along LINK 2 shown in FIG. 3A. When the location of the next extraction in descriptor list manager 200 reaches INTER_BRANCH 300, descriptor list manager 200 continues extracting WQ_ENTRYs 140c from descriptor list 210b, modifies ENTRY_BRANCH 150a to point to the newly created descriptor list 210b along LINK 3 shown in FIG. 3A, and removes INTER_BRANCH 300 from descriptor list 210a.

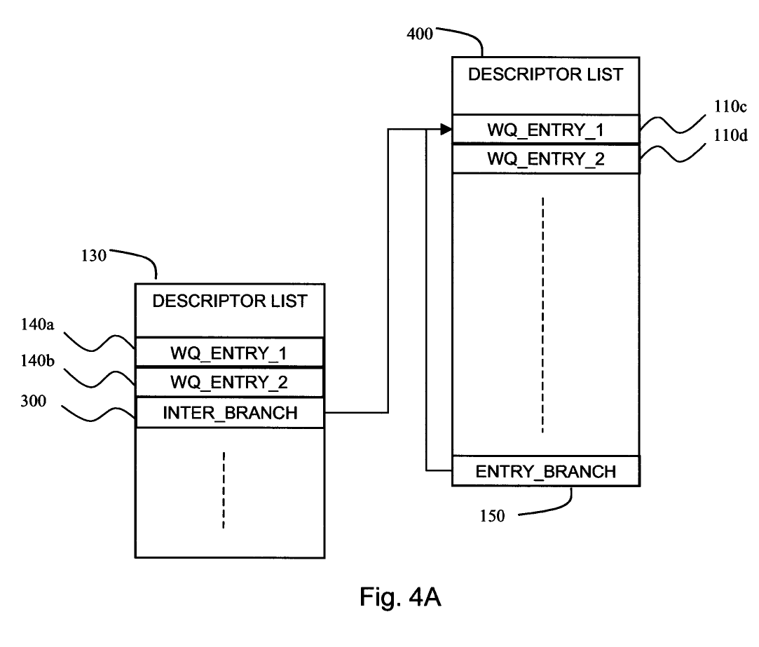

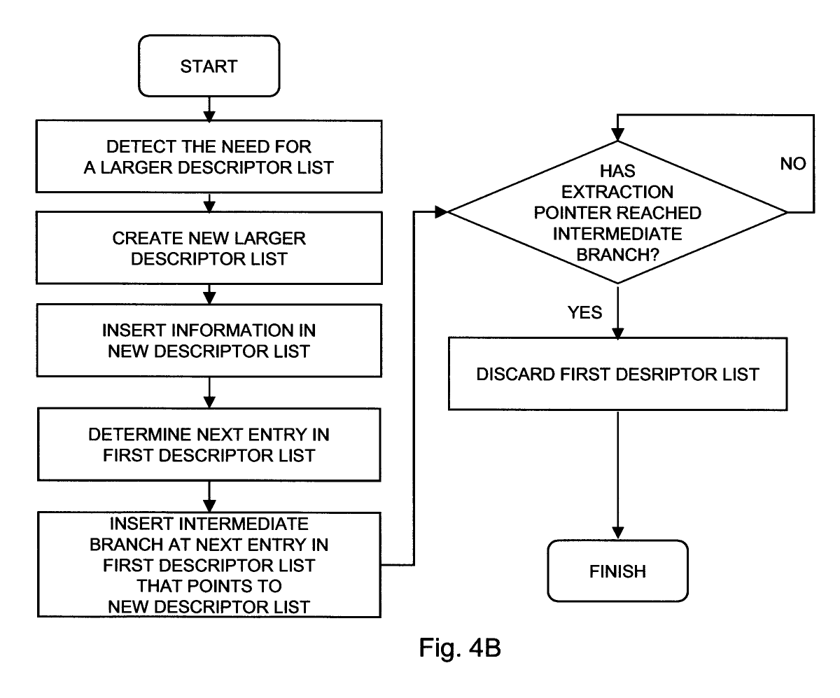

Reference is now made to FIG. 4A, which is a simplified illustration of a scaleable descriptor list, constructed and operative in accordance with a preferred embodiment of the present invention, and FIG. 4B, which is a simplified flow chart illustration of a method for resizing a descriptor list, operative in accordance with a preferred embodiment of the present invention. In the system of FIG. 4A, a fixed size descriptor list, such as descriptor list 130 shown in FIG. 1, is replaced with a fixed size descriptor list 400 of a different size. For example, NAS 110 may request that descriptor list manager 120 prepare a larger descriptor list. Descriptor manager 120 preferably creates a new larger descriptor list 400, inserts an INTER_BRANCH 300 in descriptor list 130 and subsequently places all new insertions in descriptor list 400, as described hereinabove with reference to FIGS. 3A and 3B, which points to descriptor list 400. When descriptor list manager 120's pointer to the next extraction reaches INTER_BRANCH 300, the extraction pointer is modified to point to the next available extraction location in descriptor list 400 and descriptor list 130 is removed.

Although the present invention is described with respect to managing descriptor lists in support of the TCP/IP protocol, the description is intended to be illustrative of the invention as a whole and is not to be construed as limiting the invention to the embodiments shown. It is appreciated that the present invention may be applied to the management of other kinds of lists, and that methods for the traversing lists other than by using pointers may be employed.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A system for managing descriptor lists, the system comprising:
a plurality of descriptor lists; and
a descriptor list manager operative to:
chain any of said descriptor lists by configuring at least one entry in at least a first one of said descriptor lists to indicate the location of a second one of said descriptor lists; and
manage said chain of descriptor lists as a single continuous descriptor list.

2. A system according to claim 1 wherein said configured entry is located at the end of said first descriptor list.

3. A system according to claim 1 wherein said configured entry is at a location designated as an insertion point for the next element to be inserted into said first descriptor list.

4. A system according to claim 1 wherein said first descriptor list includes a first entry located at the end of said first descriptor list and a second entry intermediate the beginning and end of said first descriptor list, wherein said first entry indicates a location within said first descriptor list and wherein said second entry indicates said location of said second descriptor list.

5. A system according to claim 4 wherein said descriptor list manager is operative to remove said second entry and configure said first entry to indicate said location of said second descriptor list.

6. A system according to claim 1 wherein said descriptor list manager is operative to remove said configured entry subsequent to designating a location in said second descriptor list as an extraction point for the next element to be extracted from said descriptor lists.

7. A system according to claim 1 wherein said descriptor list manager is operative to remove said configured entry subsequent to designating the location of said configured entry in said first descriptor list as an insertion point for the next element to be inserted into said descriptor lists.

8. A method for managing descriptor lists, the method comprising:
chaining a plurality of descriptor lists by configuring at least one entry in at least a first one of said descriptor lists to indicate the location of a second one of said descriptor lists; and
managing said chain of descriptor lists as a single continuous descriptor list.

9. A method according to claim 8 and further comprising locating said configured entry at a location designated as an insertion point for the next element to be inserted into said first descriptor list.

10. A method according to claim 8 and further comprising configuring said first descriptor list to include a first entry located at the end of said first descriptor list and a second entry intermediate the beginning and end of said first descriptor list, wherein said first entry indicates a location within said first descriptor list and wherein said second entry indicates said location of said second descriptor list.

11. A method according to claim 10 and further comprising removing said second entry and configuring said first entry to indicate said location of said second descriptor list.

12. A method according to claim 8 and further comprising removing said configured entry subsequent to designating a location in said second descriptor list as an extraction point for the next element to be extracted from said descriptor lists.

13. A method according to claim 8 and further comprising removing said configured entry subsequent to designating the location of said configured entry in said first descriptor list as an insertion point for the next element to be inserted into said descriptor lists.

14. A computer program embodied on a computer-readable medium, the computer program comprising:
a first code segment operative to chain a plurality of descriptor lists by configuring at least one entry in at least a first one of said descriptor lists to indicate the location of a second one of said descriptor lists; and
a second code segment operative to manage said chain of descriptor lists as a single continuous descriptor list.

15. A computer program according to claim 14 and further comprising a third code segment operative to locate said configured entry at a location designated as an insertion point for the next element to be inserted into said first descriptor list.

16. A computer program according to claim 14 and further comprising a third code segment operative to configure said first descriptor list to include a first entry located at the end of said first descriptor list and a second entry intermediate the beginning and end of said first descriptor list, wherein said first entry indicates a location within said first descriptor list and wherein said second entry indicates said location of said second descriptor list.

17. A computer program according to claim 16 and further comprising a fourth code segment operative to remove said second entry and configuring said first entry to indicate said location of said second descriptor list.

18. A computer program according to claim 14 and further comprising a third code segment operative to remove said configured entry subsequent to designating a location in said second descriptor list as an extraction point for the next element to be extracted from said descriptor lists.

19. A computer program according to claim 14 and further comprising a third code segment operative to remove said configured entry subsequent to designating the location of said configured entry in said first descriptor list as an insertion point for the next element to be inserted into said descriptor lists.

20. A method for implementing descriptor list management, the method comprising:
providing a plurality of descriptor lists;
providing a descriptor list manager; and
configuring said descriptor list manager to:
chain any of said descriptor lists by configuring at least one entry in at least a first one of said descriptor lists to indicate the location of a second one of said descriptor lists; and
manage said chain of descriptor lists as a single continuous descriptor list.
